(19) United States
(12) Patent Application Publication
(10) Pub. No.: US 2008/0062561 A1
(43) Pub. Date: Mar. 13, 2008

(54) Double-layered perpendicular magnetic recording media

(76) Inventors: Jianzhong Shi, Singapore (SG); S.N. Piramanayagam, Singapore (SG)

Correspondence Address: MARTINE PENILLA & GENCARELLA, LLP, 710 LAKEWAY DRIVE, SUITE 200, SUNNYVALE, CA, 94085, US

(21) Appl. No.: 11/895,320

(22) Filed: Aug. 23, 2007

(30) Foreign Application Priority Data
Aug. 24, 2006 (SG) 200605815-0

(51) Int. Cl. G11B 5/82

(52) U.S. Cl. 360/135

(57) ABSTRACT

Embodiments of the present invention provide solutions in the form of reducing the head to keeper spacing in a double-layered perpendicular magnetic recording medium, and improving the recording performance of the magnetic recording medium. A double-layered perpendicular magnetic recording medium and a method of fabricating the same are provided, for data storage devices and systems. The medium includes a base structure and a seedlayer disposed on the base structure. Further layers sequentially formed above the base structure are a soft magnetic underlayer, an intermediate layer and a magnetic recording layer. Because the soft magnetic underlayer is formed between the seedlayer and the intermediate layer, the seedlayer is excluded from the distance between the soft magnetic underlayer and the magnetic recording layer. The soft magnetic underlayer is therefore brought closer to the magnetic recording layer, providing a narrowed head-to-keeper spacing in a data storage system.

### TECHNICAL FIELD

The present invention relates to perpendicular magnetic recording media. In particular, it relates to double-layered perpendicular magnetic recording media and a method of fabricating the same.

### BACKGROUND OF INVENTION

Double-layered perpendicular magnetic recording media are proposed to provide higher recording density in data storage devices. A double-layered perpendicular magnetic recording medium includes a magnetic recording layer and a soft magnetic underlayer. The magnetic recording layer assumes the task of storing information, while the soft magnetic underlayer serves to guide magnetic flux emanating from the write head through the magnetic recording layer, which doubles the write field and increases write field gradient, as compared to longitudinal magnetic recording media.

FIG. 1 shows a typical double-layered perpendicular magnetic recording medium 100, which includes a substrate 10, an adhesion layer 12 with an amorphous structure and a thickness of 0.5-5.0 nm formed on the substrate 10, a soft magnetic underlayer (SUL in short, or referred to as “keeper”) 14 with an amorphous structure and a thickness of 50-200 nm formed on the adhesion layer 12, a seedlayer 16 with an amorphous structure and a thickness of 0.5-5.0 nm formed on soft magnetic underlayer 14, an intermediate layer 18 with a crystalline structure and a thickness of 2.0-30 nm formed on the soft magnetic under layer 14, and a magnetic recording layer 20 formed on the intermediate layer 18. Overcoat layer 22 and lubricant layer 24 are formed on magnetic recording layer 20. When in use, a read/write head 28 of a data storage device 26, is positioned over a media disc 11 formed of the double-layered perpendicular magnetic recording medium 100, to perform data read/write operations.

To concentrate the write flux and increase the write field gradient, it is desirable to minimize the distance between the read/write head 28 and the soft magnetic underlayer 14, referred to hereinafter as head-to-keeper spacing (HKS) D1. To reduce the HKS, one approach is to reduce the thickness of the intermediate layer 18. In a 1 Tb/In² recording medium, theory predicts that the intermediate layers should have a thickness of 0-1 nm. However, if the thickness of the intermediate layer is reduced to such range, the grains of the intermediate layers and the magnetic recording layer will be pointing at random directions. Consequently, a magnetic medium with an intermediate layer of this thickness will possess a very low out-plane coercivity (Hc), and a wide c-axis orientation dispersion (Δθ₅₀). This random grain orientation of the magnetic recording layer can also give rise to a reduction in the signal-to-noise ratio. As such, a mere reduction of the thickness of the intermediate layer may not provide a magnetic recording medium with satisfactory magnetic properties.

In another approach, the amorphous soft magnetic underlayer (a-SUL) is replaced by a crystalline soft magnetic underlayer (c-SUL), such as a soft magnetic underlayer with a face-centered-cubic (fcc) structure or a hexagonal-close-cubic (hcp) structure. The thickness of the intermediate layer can be reduced under this approach, and the intermediate layer may still possess a narrow c-axis orientation dispersion (Δθ₅₀).

However, this approach has certain drawbacks. For example, the grain size in a c-SUL is relatively large, and the surface roughness is high. As such, a magnetic recording medium having the a-SUL replaced with a c-SUL will have considerable high level of media noise, and a lower signal-to-noise ratio.

It is therefore desirable to provide a double-layered perpendicular magnetic recording medium having a structure to enable a reduced head-to-keeper spacing, without substantially compromising the magnetic recording performance of the magnetic recording media. Unfortunately, such a solution is presently unavailable.

### SUMMARY OF INVENTION

Embodiments of the present invention provide solutions in the form of reducing the head to keeper spacing in a double-layered perpendicular magnetic recording medium, and improving the recording performance of the magnetic recording medium.

According to one aspect, there is provided a double-layered perpendicular magnetic recording medium for data storage devices and systems. The medium includes a base structure formed of a substrate and a seedlayer layer disposed on the substrate. The base structure includes a substrate and an adhesion layer. Further layers sequentially formed above the base structure are a crystalline soft magnetic underlayer, an intermediate layer and a magnetic recording layer.

Because the crystalline soft magnetic underlayer is formed between the seed layer and the intermediate layer, the seedlayer is excluded from the distance between the soft magnetic underlayer and the magnetic recording layer. The soft magnetic under is therefore brought closer to the magnetic recording layer. A media disk according to embodiments of the present invention can therefore provide a narrowed head-to-keeper spacing in a data storage system.

According to another aspect, there is provided a method of fabricating a double-layered perpendicular magnetic recording medium. A base structure is firstly provided in a sputtering chamber, and a seedlayer is then formed of the base structure. Thereafter, a crystalline soft magnetic underlayer is formed above the seedlayer. On the soft magnetic underlayer there are further formed an intermediate layer and a magnetic recording layer.

### BRIEF DESCRIPTION OF THE DRAWINGS

These and other aspects and advantages of the present invention will be described in detail with reference to the accompanying drawings, in which:

FIG. 1 is a schematic cross sectional view of a conventional double-layered magnetic recording medium;

FIG. 2 is a partial schematic cross sectional view of a double-layered perpendicular magnetic recording medium according to one embodiment of the present invention;

FIG. 3A is a flow chart showing a method of forming a double layered perpendicular magnetic recording medium according to one embodiment of the present invention;

FIG. 3B is a partial schematic cross sectional view of a double-layered perpendicular magnetic recording medium formed according to a method shown in FIG. 3A;

FIG. 3C is a chart showing soft magnetic underlayer noise curves of a medium made according to a method shown in FIG. 3A, and compared to the noise curve of a conventional magnetic recording medium;

FIG. 4A is a flow chart showing a method of forming a double layered perpendicular magnetic recording medium according to another embodiment of the present invention;

FIG. 4B is a partial schematic cross sectional view of a double-layered perpendicular magnetic recording medium formed according to a method shown in FIG. 4A;

FIG. 4C is a chart showing soft magnetic underlayer noise curves of a medium made according to the method shown in FIG. 4A, and compared to one of a conventional magnetic recording medium;

FIG. 5A is a partial schematic cross sectional view of a double-layered perpendicular magnetic recording medium according to another embodiment of the present invention;

FIG. 5B is a flow chart showing a method of forming a double layered perpendicular magnetic recording medium of FIG. 5A;

FIG. 5C is a partial schematic cross sectional view of a double-layered perpendicular magnetic recording medium formed according to a method shown in FIG. 5B;

FIG. 5D is a chart showing soft magnetic underlayer noise curves of a medium made according to a method shown in FIG. 5B, and compared to one of a conventional magnetic recording medium;

FIG. 6A is a partial schematic cross sectional view showing the structure of a soft magnetic underlayer in a double-layered magnetic recording medium according to a further embodiment of the present invention.

FIG. 6B is a flow chart showing a method of forming a double layered perpendicular magnetic recording medium of FIG. 6A;

FIG. 6C is a chart showing soft magnetic underlayer average roughness curves of a medium made according to a method shown in FIG. 6B;

FIG. 6D is a chart showing soft magnetic underlayer c-axis orientation dispersion curves of a medium made according to a method shown in FIG. 6B.

### DETAILED DESCRIPTION OF THE PREFERRED EMBODIMENTS

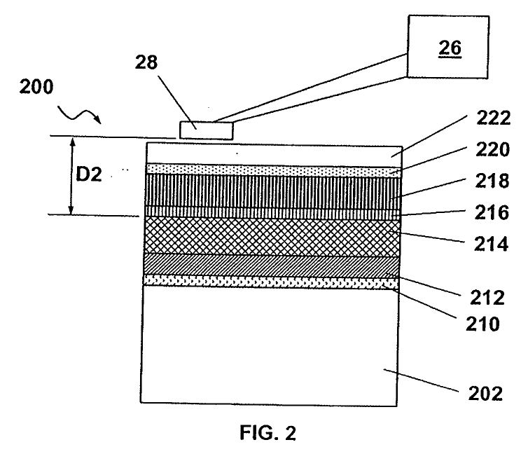

Referring now to FIG. 2, a double-layered perpendicular magnetic recording medium 200 according to one embodiment of the present invention includes a substrate 202, an adhesion layer 210 formed on substrate 202, and a seedlayer 212 formed on adhesion layer 210. A soft magnetic underlayer 214 is formed on seedlayer 212, and an intermediate layer 216 is formed on soft magnetic underlayer 214. On top of intermediate layer 216 there is formed a magnetic recording layer 218. Further layers may be formed on top of magnetic recording layer, such as an overcoat layer 220 and a lubricant layer 222.

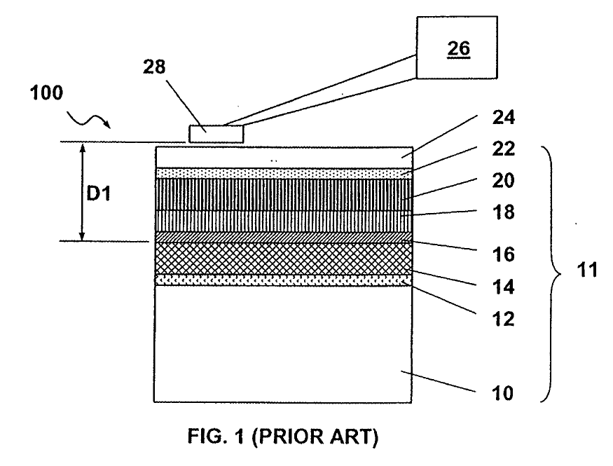

As shown in FIG. 2, with the soft magnetic underlayer 214 formed between seedlayer 212 and magnetic recording layer 218, the head-to-keeper spacing D2 is reduced compared to the head-to-keeper spacing D1 of the conventional magnetic recording media shown in FIG. 1, as the seedlayer layer is excluded from the head-to-keeper spacing. Thus, by arranging the seedlayer and the soft magnetic underlayer in this manner, the soft magnetic underlayer is brought closer to the top surface of the magnetic recording medium. The present embodiment therefore makes it possible to reduce the head-to-keeper spacing in a data storage device.

In one example, the seedlayer 212 and intermediate layer 216 are made of ruthenium (Ru), the soft magnetic underlayer 214 is made of FeCo-based materials with additive elements, such as FeCoTaCr with compositions of about 14 at % of Fe, of 80 at % of Co, 3 at % of Ta and 3 at % of Cr, and magnetic recording layer 218 is made of CoCrPt:SiO₂. The additive elements in FeCo based soft underlayer can be Cr, Ta, Cu, Al etc. The main objectives of these elements are to reduce the grain size and to protect the FeCo layer from getting corroded. The adhesion layer 210 is made of Ta. During the deposition of soft magnetic underlayer 214 in a sputtering chamber, the Argon gas pressure in the sputtering chamber is between about 1.5 mTorr to about 7.5 mTorr.

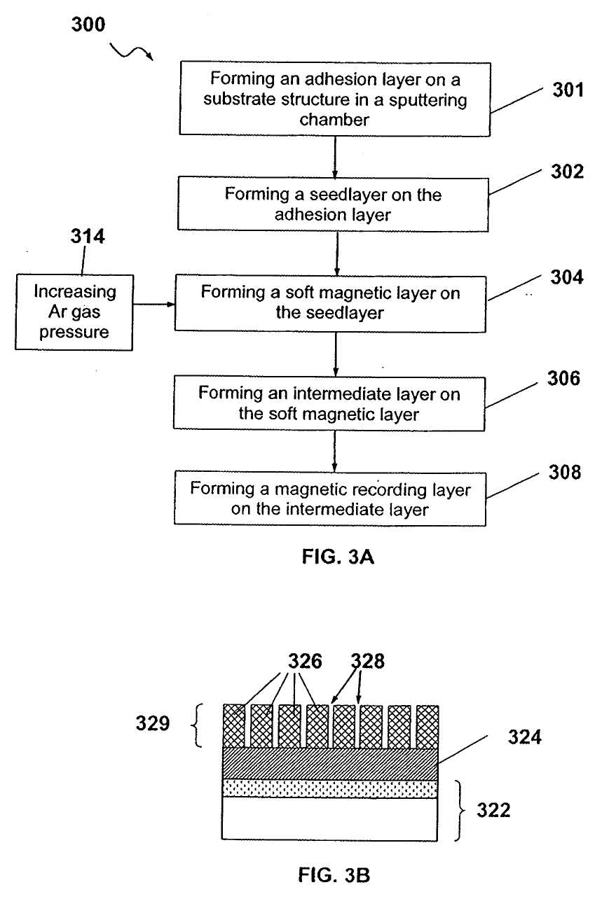

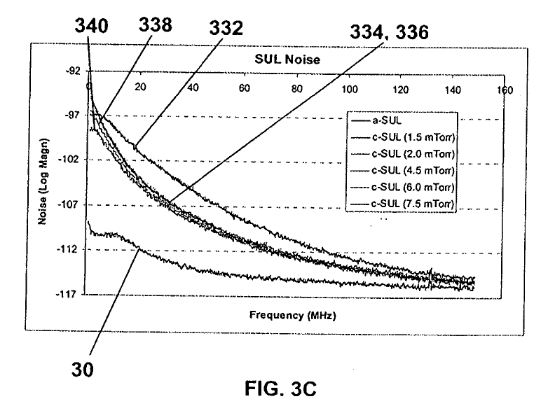

FIG. 3A is a flow chart showing a method 300 of fabricating a double-layered perpendicular magnetic recording medium, according to one embodiment of the present invention. A substrate structure, including a substrate made of Al—Mg alloy or glass, is placed in a sputtering chamber. An adhesion layer is firstly formed on the substrate structure, as shown in block 301. In block 302, a seedlayer is then formed on the adhesion layer. Thereafter, as shown in block 304, a soft magnetic underlayer is formed on the seedlayer. Further, as shown in block 306, an intermediate layer is formed on the soft magnetic underlayer. A magnetic recording layer is then formed on the intermediate layer, as shown in block 308.

In one embodiment, the sputtering chamber air pressure, i.e. the argon gas pressure, is increased during the formation of the soft magnetic under layer, as shown in block 314. When the argon gas pressure is increased in the sputtering chamber, a column growth of the magnetic grains with a void boundary surrounding the magnetic grain occurs in the soft magnetic underlayer, as shown in FIG. 3B.

FIG. 3B is a partial schematic cross sectional view of a double-layered perpendicular magnetic recording medium, with a seedlayer 324 formed on a base structure 322, and a soft magnetic underlayer 329 formed on seedlayer 324.

By controlling the argon gas pressure introduced into the sputtering chamber during formation of the soft magnetic underlayer, segregated magnetic grains 326 can be formed in the soft magnetic underlayer 329, together with a void boundary 328 formed in the soft magnetic underlayer 329. Void boundary 328 surrounds the magnetic grains 326, and separates the grains 326 from each other. Separated by void boundary 328, the exchange coupling between the magnetic grains 326 in the soft magnetic underlayer 329 is weakened and consequently, the noise is reduced. The higher the argon gas pressure, the larger the boundary size, and the weaker the exchange coupling, the lower the noise.

FIG. 3C shows the experimental results of noise measurements for magnetic media formed by a method showing in FIG. 3A. In FIG. 3C, the experiment results show that the noise level of soft magnetic underlayer 329 is reduced with increase of the argon gas pressure, shown as curves 332, 334, 336, 338 and 340 under various pressures from about 1.5 mTorr to about 7.5 mTorr. A comparative curve 30 of an amorphous SUL structure made of CoTaZr is also shown in FIG. 3C. It can be seen that with increasing of the argon gas pressure, the noise level of the medium using c-SUL can be reduced, to a level closer to the noise of a medium using a-SUL.

Table I summarizes part of the parameters and experiment results under the present embodiment. In perpendicular magnetic recording media, the head-to-keeper spacing (HKS), i.e. head-to-soft magnetic underlayer spacing is required as narrow as possible. This requires the hard layer-to-soft magnetic underlayer spacing (HSS), i.e. the distance between the magnetic recording layer (also referred to as “hard layer”) and the soft magnetic underlayer as small as possible. By adopting a c-SUL, the HSS is much reduced from 18 nm (as is the case when an a-SUL is adopted) to 5 nm. In the meantime, the c-axis orientation dispersion Δθ₅₀ of the soft magnetic underlayer is reduced to 3-3.2 degrees from 4.5 degrees.

TABLE I
Part of parameters and experiment results

| | HSS (nm) | Δθ₅₀ of soft magnetic underlayer (degree) |
|---|---|---|
| Media on c-SUL | 5 | 3.0-3.2 |
| Media on a-SUL | 18 | 4.5 |

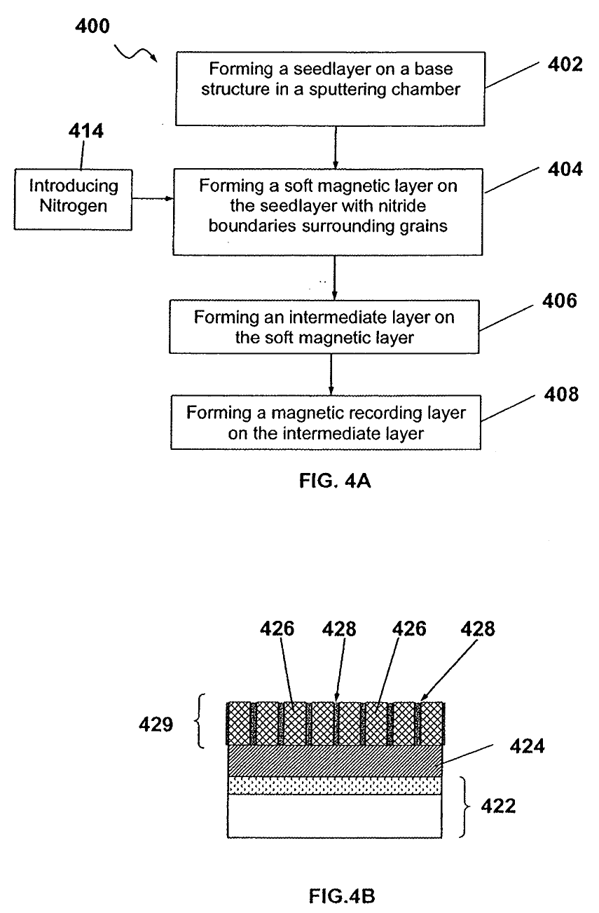

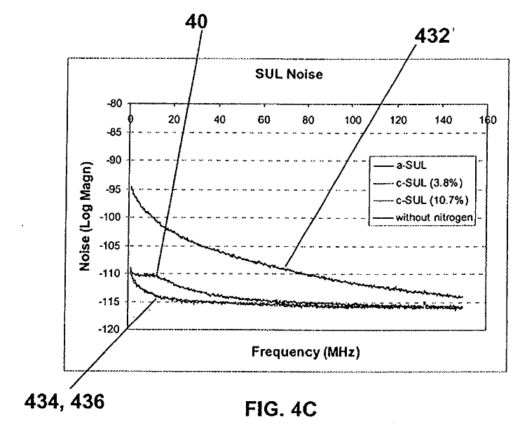

FIG. 4A is a flow chart showing a method 400 of fabricating a double-layered perpendicular magnetic recording medium, according to another embodiment of the present invention. FIG. 4B is a partial schematic cross sectional view of a double-layered perpendicular magnetic recording medium, with a seedlayer 424 formed on a base structure 422, and a soft magnetic underlayer 429 formed on seedlayer 424.

To fabricate a double-layered perpendicular magnetic recording medium according to the present embodiment, as shown in FIG. 4A, a substrate structure, including a substrate made of Al—Mg alloy or glass, is placed in a sputtering chamber. An adhesion layer is firstly formed on the substrate structure, in a manner similar to that shown in the previous embodiment. For ease of illustration, the substrate and adhesion layer together are referred to as a base structure in FIG. 4A. In block 402, a seedlayer is formed on the base structure. Thereafter, as shown in block 404, a soft magnetic underlayer is formed on the seedlayer.

A nitrogen gas is introduced into the sputtering chamber, shown in block 414, during the formation of the soft magnetic underlayer. The nitrogen gas reacts with the materials used for forming the soft magnetic underlayer, such as Ta, Cr, and forms a Ta-nitride and/or a Cr-nitride. The nitrides form a boundary 428 surrounding the magnetic grains 426 in the soft magnetic underlayer 429, as shown in FIG. 4B. Since the nitrides 428 located in the boundary area are non-magnetic materials, the magnetic grains 426 are separated magnetically decoupled from each other, hence the noise can be reduced in this way.

Experiment results present, as shown in FIG. 4C, that the noise level of soft magnetic underlayer with a crystalline structure is reduced with the introduction of nitrogen during formation of the soft magnetic underlayer, shown as curves 434 and 436, when the nitrogen content is at 3.8% and 10.7%, respectively. Comparing to curve 432 (which shows the noise level of a medium formed without nitrogen content), the noise level of the soft magnetic underlayer under the present embodiment is significantly reduced, to a level which is even lower than that measured from an amorphous soft magnetic underlayer, as indicated by comparative curve 40.

Table II summarizes part of the parameters and experiment results under the present embodiment. The HSS is much reduced from 18 nm (as is the case when an a-SUL is adopted) to 5 nm. In the meantime, the c-axis orientation dispersion of the magnetic layer is about 4.6-5.8 degrees.

TABLE II
Part of parameters and experiment results

| | | | Δθ₅₀ of soft |
|---|---|---|---|
| | Nitrogen content | HSS | magnetic |
| | (in volume) (%) | (nm) | underlayer (degree) |
| Media on c-SUL | 3.8 | 5 | 4.6 |
| | 10.7 | 5 | 5.8 |
| Media on a-SUL | — | 18 | 4.5 |

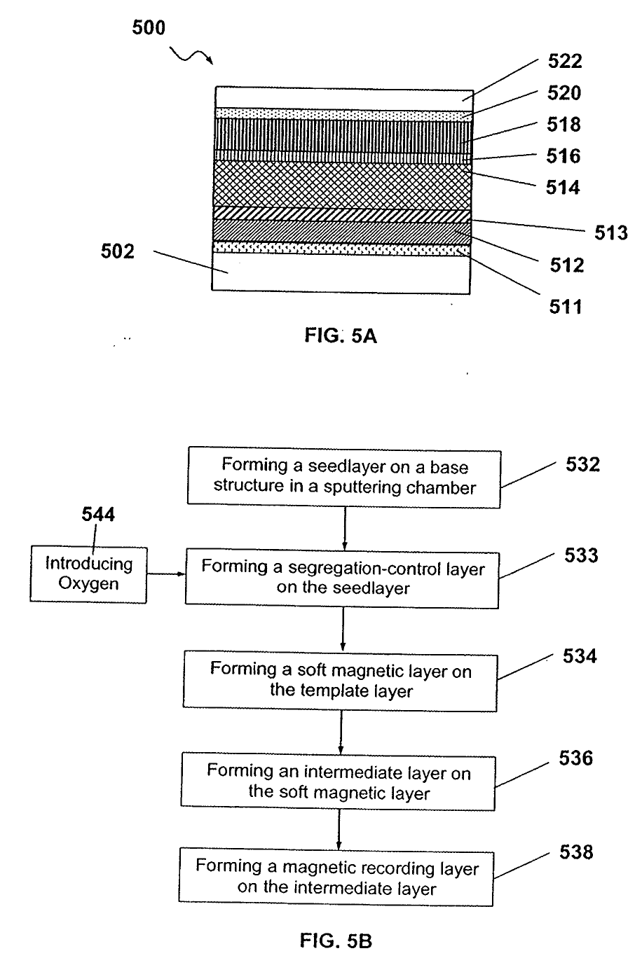

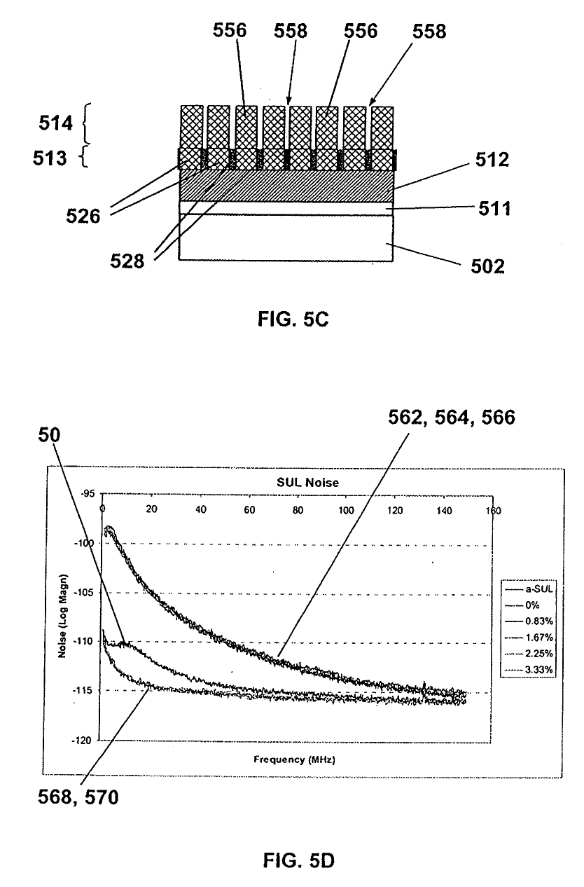

As shown in FIGS. 5A and 5B, a double-layered perpendicular magnetic recording medium 500 according to yet another embodiment of the present invention includes a substrate 502, an adhesion layer 511 formed on substrate 502, and a seedlayer 512 formed on the adhesion layer 511 in a sputtering chamber, as shown in FIG. 5B at block 532. A segregation-control layer 513 is formed at block 533 (FIG. 5B), on the seedlayer 512. A soft magnetic underlayer 514 is formed on segregation-control layer 513, shown at block 534 (FIG. 5B), and an intermediate layer 516 is formed on soft magnetic underlayer 514, shown at block 536 (FIG. 5B). On top of the intermediate layer 516 there is formed a magnetic recording layer 518, shown at block 538 in FIG. 5B. Further layers may be formed on top of the magnetic recording layer, such as an overcoat layer 520 and a lubricant layer 522.

In the present embodiment, the segregation-control layer 513 is made of RuCr. During the deposition of segregation-control layer 513, an oxygen gas is introduced into the sputtering chamber, as shown in block 544 in FIG. 5B. The oxygen gas serves as the reactive sputtering gas.

As shown in FIG. 5C, during the formation of segregation-control layer 513, the oxygen reacts with Cr, and forms Cr-oxide 528. Cr-oxide are located in the boundaries of the RuCr grains 526 in the segregation-control layer 513. The RuCr grains 526 are therefore separated from one another by the Cr-oxide boundary 528.

During the formation of the soft magnetic layer 514 on top of the segregation-control layer 513, the crystalline soft magnetic underlayer 514 with crystalline structure is formed, with the magnetic grains 556 of the soft underlayer grow on top of the RuCr grains 526 in the segregation-control layer 513. In other words, one magnetic grain of soft magnetic underlayer 514 grows on one top of a RuCr grain of the segregation-control layer, by epitaxial growth due to lattice matching.

Because the RuCr grains 526 are separated by Cr-oxide boundary 528 in the segregation-control layer 513, the magnetic grains 556 are also separated by a void boundary 558 in the soft magnetic underlayer 514, as shown in FIG. 5C. Thus, segregation-control layer 513 serves to form segregated magnetic grains 556 in soft magnetic underlayer 514.

As the magnetic grains 556 are separated by void boundary 558, the exchange coupling between the magnetic grains in the soft underlayer becomes weak, and therefore the noise is reduced.

Experiment results present, as shown in FIG. 5D, that when the oxygen gas partial pressure percentage is more than about 1.67%, the noise level of the soft magnetic underlayer can be significantly reduced as indicated by curves 568 and 570 which represents oxygen gas partial pressure of 2.25% and 3.33, respectively. In FIG. 5D, a noise curve 50 of soft underlayer with an amorphous structure and noise curves 562, 564 and 566 measured under the oxygen gas partial pressure of lower than 1.67%, are also given for comparison.

Table III summarizes part of the parameters and experiment results under the present embodiment. The HKS is much reduced to 5 nm, while the c-axis orientation dispersion Δθ₅₀ of the magnetic layer is slightly increased to only 4.6-5.8 degrees.

TABLE III
Part of parameters and experiment results

| | | | Δθ₅₀ of soft |
|---|---|---|---|
| | Oxygen content(in | HSS | magnetic |
| | volume) (%) | (nm) | underlayer (degree) |
| Media on c-SUL | 3.8 | 5 | 4.6 |
| | 10.7 | 5 | 5.8 |
| Media on a-SUL | — | 18 | 4.5 |

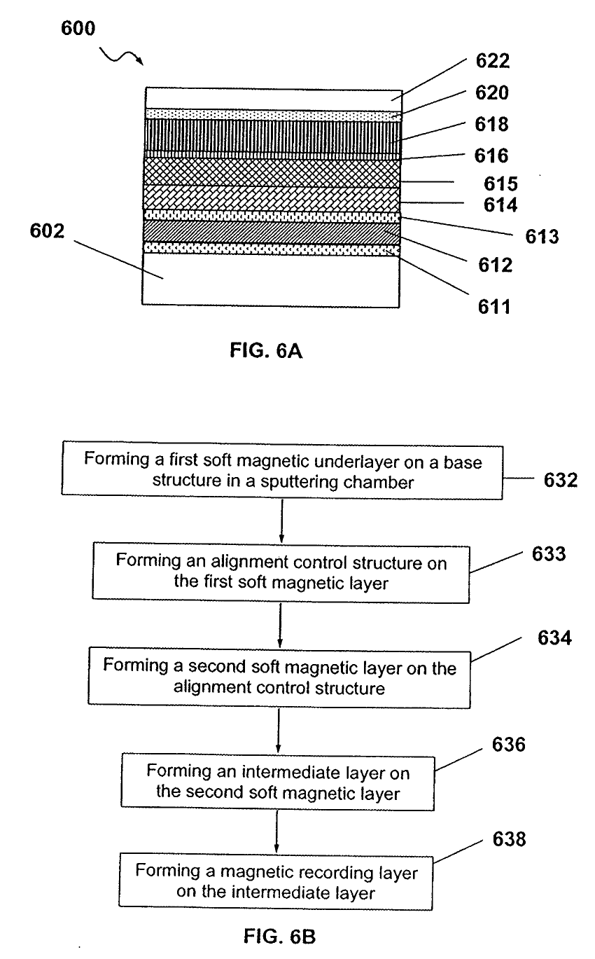

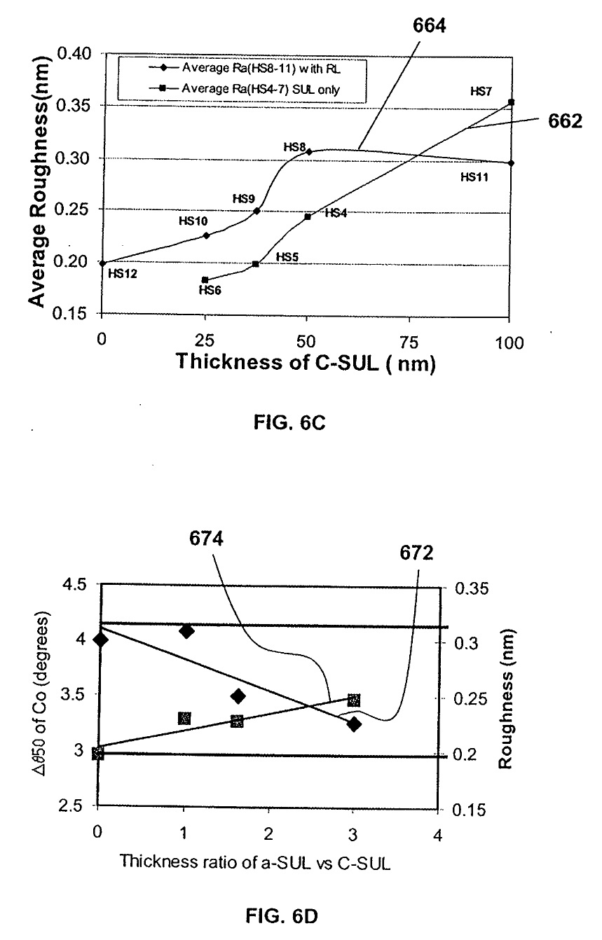

As shown in FIGS. 6A and 6B, a double-layered perpendicular magnetic recording medium 600 according to a further embodiment of the present invention includes a substrate 602, an adhesion layer 611 formed on substrate 602, and a first soft underlayer 612 formed on the adhesion layer 611 in a sputtering chamber, as shown in FIG. 6B at block 632. For ease of illustration, the substrate 602 and the adhesion layer 611 are referred to as a base structure in FIG. 6B.

In the present embodiment, the double-layered perpendicular magnetic recording medium includes two soft magnetic underlayers, of which one is amorphous and another is crystalline. In the most-preferred format, the first soft magnetic underlayer is an amorphous soft magnetic underlayer, and is formed closer to the substrate. The second soft magnetic underlayer is a crystalline soft magnetic underlayer, and is formed closer to the magnetic recording layer. An alignment control layer 613 is formed on the first soft magnetic underlayer 612, and on top of alignment control layer 613, a seedlayer 614, which maybe made of Ru, Pd or materials with similar structure that grow with a hcp(00.2) or fcc(111) texture, are deposited.

According to an alternative embodiment, the hcp(00.2) of fcc(111) texture in the crystalline soft underlayer may be achieved with alignment control layer only, hence a seedlayer is not necessary in this embodiment.

For the purpose of clarity, alignment control layer 613 with or without seedlayer 614 is referred to together as an alignment control structure in block 633 (FIG. 6B). A second soft magnetic underlayer 615 is formed on seedlayer 614, shown at block 634 (FIG. 6B). An intermediate layer 616 is formed on second soft magnetic underlayer 615, shown at block 636 (FIG. 6B). On top of the intermediate layer 616 there is formed a magnetic recording layer 618, shown at block 638 in FIG. 6B. Further layers may be formed on top of the magnetic recording layer, such as an overcoat layer 620 and a lubricant layer 622.

In the present embodiment, the first soft magnetic underlayer 612 has an amorphous structure, and the second soft magnetic underlayer 615 has a crystalline structure, such as FeCo alloy with fcc (111) texture. An amorphous first soft magnetic underlayer has the advantage of providing a smooth surface for the other layers to grow thereon, and exhibits a lower noise during data read-back operations. By providing a crystalline second soft magnetic layer, the growth of the intermediate layer 616 and the magnetic recording layer 618 follows the crystalline structure of the second soft magnetic underlayer 615. As such, a crystalline second soft magnetic underlayer enables the thickness reduction of intermediate layer 616, and improves the perpendicular c-axis orientation at thinner intermediate layer. In the present embodiment, the thickness of the intermediate layer can be reduced to about 5 nm without substantially compromising the magnetic properties

According to another embodiment, the first soft magnetic underlayer may be split into two parts, with a coupling layer sandwiched therebetween, to form a synthetic antiferromagnetic structure. In one example, the coupling layer is made of Ru, and the synthetic antiferromagnetic structure is in the form of an SUL/Ru/SUL structure, where the thickness of Ru-coupling layer may be from 0.3-1 nm. In such structures, the Ru-coupling layer introduced between the two soft magnetic underlayers provides an antiferromagnetic coupling between the two SULs to further reduce or minimize the noise of the medium.

According to another embodiment, the second soft magnetic underlayer is split into two parts, with a coupling layer sandwiched therebetween, to form a synthetic antiferromagnetic structure. In one example, the coupling layer is made of Ru, and the synthetic antiferromagnetic structure is in the form of an SUL/Ru/SUL structure, where the thickness of Ru-coupling layer may be from 0.3-1 nm. In such structures, the Ru-coupling layer introduced between the two soft magnetic underlayers provides an antiferromagnetic coupling between the two SULs to further reduce or minimize the noise of the medium.

A perpendicular magnetic recording medium structured with both amorphous and crystalline soft magnetic underlayers has a lower roughness, a thinner intermediate layer, together with magnetic properties and c-axis orientation at a level comparable to those in a medium with amorphous soft magnetic layer.

Table IV shows the structures of the samples studied and experiment results under the present embodiment as shown in FIGS. 6A and 6B. In conventional perpendicular recording media, there are two intermediate layers, of which the bottom one (for example Ruthenium) is sputtered at lower pressures and the top one (for example Ru, CoRu, or RuCr) is sputtered at higher pressures. The difference between the structure in Table III and the conventional perpendicular recording media is that, in the structure according to embodiments of the present invention, a crystalline soft magnetic underlayer, made of FeCoCrTa for example, is inserted between the first Ruthenium layer (Ru1) and the second Ruthenium layer (Ru2) of conventional perpendicular magnetic recording medium. Experiment results show that formed with a crystalline soft magnetic underlayer and an amorphous soft magnetic underlayer, the Δθ₅₀ is reduced (from about 3.8 degrees normally seen in conventional structure, to about 3.1 degrees of sample HS3). From the results of samples HS1-HS3, it is clear that about 6 nm of Ru1 layer is good enough to achieve a low Δθ₅₀ of 3.3 degrees. This is not achievable without a c-SUL provided in between Ru1 and Ru2. These results indicate that, having a c-SUL sandwiched between Ru1 and Ru2 helps to reduce the Δθ₅₀. It is also observed that the surface roughness of the samples are not very high as compared to that of samples with c-SUL only. From the information above, it is decided to keep the Ru1 layer to be about 6 nm in all the samples with two soft magnetic underlayers for further study and investigation.

TABLE IV
Samples with an a-SUL and a C-SUL.

| | CoTaZr | | | FeCoCrTa | | | Δθ₅₀ of | |
|---|---|---|---|---|---|---|---|---|
| Sample | (a-SUL) | Ta | Ru1 | (C-SUL) | Ru2 | CoCrPtSiO₂ | Co (00.2) | Hc |
| Code | (nm) | (nm) | (nm) | (nm) | (nm) | (nm) | (degrees) | (kOe) |
| HS1 | 100 | 4 | 3 | 25 | 6 | 14 | 3.7 | 8196 |
| HS2 | 100 | 4 | 6 | 25 | 6 | 14 | 3.3 | 8179 |
| HS3 | 100 | 4 | 9 | 25 | 6 | 14 | 3.1 | 7761 |

Table V shows the structures of the samples studied and experiment results under the present embodiment, with other parameters. In these samples, the thickness of Ta and Ru1 layers were maintained the same, with a total thickness of 10 nm. The thickness ratio of the a-SUL and the c-SUL are also investigated. Two sets of samples are prepared. In one set of samples, only SULs are prepared, in order to study the noise of the SULs. In another set of samples, two SULs with recording layers are also prepared. Table V also shows the Ra, Δθ₅₀ and Hc of the samples.

It can be seen from Table V that the sample with only c-SUL shows a high roughness (Ra), where the lowest roughness is obtained in samples with a-SUL only. On the other hand, the sample with a-SUL shows a larger Δθ₅₀ and a low Hc for the same conditions of depositions. However, the samples with both a-SUL and c-SUL (thickness of 25-38 nm) show the best combination of Ra and Δθ₅₀.

TABLE V
Samples with two SULs (with different ratios of a-SUL and c-SUL).

| | Thickness | | | | | | | | |
|---|---|---|---|---|---|---|---|---|---|
| | | | | | Magnetic | Ratio of | | | |
| | | Ta/ | | | Recording | a-SUL to c- | | Δθ₅₀ of | |
| Sample | a-SUL | Ru1 | c-SUL | Ru2 | Layer | SUL | Ra | Co (00.2) | Hc |
| Code | (nm) | (nm) | (nm) | (nm) | (nm) | thickness | (nm) | (degrees) | (kOe) |
| HS4 | 50 | 10 | 50 | 0 | 0 | 1 | 0.245 | | |
| HS5 | 62 | 10 | 38 | 0 | 0 | 1.63 | 0.199 | | |
| HS6 | 75 | 10 | 25 | 0 | 0 | 3 | 0.183 | | |
| HS7 | 0 | 10 | 100 | 0 | 0 | 0 | 0.357 | | |
| HS8 | 50 | 10 | 50 | 6 | 14 | 1 | 0.308 | 3.29 | 7683 |
| HS9 | 62 | 10 | 38 | 6 | 14 | 1.63 | 0.250 | 3.27 | 7199 |
| HS10 | 75 | 10 | 25 | 6 | 14 | 3 | 0.226 | 3.47 | 7422 |
| HS11 | 0 | 10 | 100 | 6 | 14 | 0 | 0.299 | 2.96 | 7994 |
| HS12 | 100 | 10 | 0 | 6 | 14 | a-SUL only | 0.197 | 4.14 | 3556 |

FIG. 6C shows the trend of average roughness (Ra) of samples with a-SUL and c-SUL and full layer structure with the data from Table V, where RL denotes recording layer. Usually, crystalline layer deposited by sputtering technology has higher Ra than amorphous layer. In this experiment, the total thickness of a-SUL and c-SUL is kept the same (100 nm). By increasing the c-SUL thickness, the Ra of the samples with the first and second SULs and full layer structure also increases. The experimental data show that magnetic recording media formed of first and second SULs has superior magnetic properties, since it has lower surface roughness, compared to that formed of a single c_SUL. Such superior magnetic properties are desirable for high-density perpendicular magnetic recording media.

FIG. 6D shows the Δθ₅₀ and average roughness of the samples with two SULs according to the data from Table V. By increasing the thickness ratio of a-SUL to c-SUL, the Ra of the samples with first and second SULs and full layer structure reduces, as indicated by curve 672, while the Δθ₅₀ of Co(00.2) increase a little from about 3 degrees to 3.5 degrees, as indicated by curve 674. Especially, with a 25 nm c-SUL, the Ra of the media is 0.226 nm and the Δθ₅₀ of Co(00.2) is 3.47 degrees, which is quite promising for high-density perpendicular recording media.

Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. A double-layered perpendicular magnetic recording medium comprising:
a base structure;
a seedlayer above the base structure,
a soft magnetic underlayer above the seedlayer
an intermediate layer above the soft magnetic underlayer; and
a magnetic recording layer above the intermediate layer

2. The medium of claim 1, wherein the soft magnetic underlayer is a crystalline soft magnetic underlayer with magnetic grains segregated from each other.

3. The medium of claim 2, wherein the soft magnetic underlayer further includes a boundary isolating the magnetic grains.

4. The medium of claim 3, wherein the boundary is a void boundary.

5. The medium of claim 3, wherein the boundary is a solid boundary.

6. The medium of claim 3, wherein the solid boundary is formed of a nitride.

7. The medium of claim 2, wherein the segregated grains have an fcc structure with [111] direction normal to a main surface of the soft magnetic underlayer.

8. The medium of claim 1, further comprising a segregation-control layer formed underneath the soft magnetic underlayer.

9. The medium of claim 8, wherein segregation-control layer comprises crystalline grains separated by a boundary structure.

10. The medium of claim 9, wherein the boundary structure is formed of oxides.

11. The medium of claim 9, wherein the soft magnetic underlayer comprises magnetic grains on top of the crystalline grains of the segregation-control layer, wherein the magnetic grains are separated from each other.

12. The medium of claim 1, wherein the soft magnetic underlayer is a crystalline soft magnetic under layer, wherein the medium further comprises an amorphous soft magnetic underlayer under the crystalline soft magnetic under layer.

13. The medium of claim 12, wherein a ratio of thickness of the amorphous soft magnetic underlayer to crystalline soft magnetic underlayer is between about 1 to 5.

14. The medium of claim 13, further comprising an alignment control layer above the amorphous soft magnetic underlayer.

15. The medium of claim 14, wherein the amorphous soft magnetic underlayer is split into two parts with a coupling layer sandwiched therebetween to form antiferromagnetic coupling among the two parts of the amorphous soft magnetic layer.

16. The medium of claim 14, wherein the crystalline soft magnetic underlayer is split into two parts with a coupling layer sandwiched therebetween to form antiferromagnetic coupling among the two parts of the crystalline soft magnetic layer.

17. A method of fabricating a perpendicular magnetic recording medium, comprising:
providing a base structure in a sputtering chamber;
forming a seedlayer on the base structure;
forming a soft magnetic underlayer above the seedlayer;
forming an intermediate layer on the soft magnetic underlayer, and
forming a magnetic recording layer formed on the intermediate layer.

18. The method of claim 17, wherein during forming the soft magnetic layer, increasing an argon gas pressure in the sputtering chamber to form segregated magnetic grains in the soft magnetic layer.

19. The method of claim 18, wherein the argon gas pressure is about 1.5 mTorr to about 80 mTorr.

20. The method of claim 18, wherein the segregated magnetic grains have an fcc structure with [111] direction normal to a main surface of the soft magnetic underlayer.

21. The method of claim 17 further comprising, during forming the soft magnetic layer, introducing an nitrogen gas into the sputtering chamber, wherein introducing the nitrogen gas is to react with materials used for forming the soft magnetic underlayer to form nitrides.

22. The method of claim 21, wherein the nitrogen gas has a content of about 3.8% to about 10.7%.

23. The method of claim 21, wherein the nitrides forms a boundary separating magnetic grains in the soft magnetic underlayer.

24. The method of claim 17 further comprising, prior to forming the soft magnetic underlayer, forming a segregation-control layer on the seed layer, and wherein forming the soft magnetic underlayer forms the soft magnetic underlayer on the segregation-control layer.

25. The method of claim 24 further comprising, during forming the segregation-control layer, introducing an oxygen gas into the sputtering chamber, wherein the oxygen gas is to react with materials used for forming the segregation-control layer to form oxides.

26. The method of claim 25, wherein the oxygen gas has a partial pressure percentage of at least about 1.67%.

27. The method of claim 25, wherein the oxides forms a boundary separating crystalline grains in the segregation-control layer.

28. The method of claim 27, wherein forming the soft magnetic underlayer grows magnetic grains on the crystalline grains of the segregation-control layer, wherein the magnetic grains are separated from each other.

29. The method of claim 24, wherein the segregation-control layer is made of RuCr or CoCr with a hcp structure with the [00.2] direction normal to a main surface of the base structure.

30. The method of claim 17, wherein the soft magnetic underlayer is a crystalline soft magnetic underlayer, the method further comprising, prior to forming the crystalline soft magnetic underlayer, forming an amorphous soft magnetic underlayer above the base structure.

31. The method of claim 30, wherein a ratio of thickness of the amorphous soft magnetic underlayer to crystalline soft magnetic underlayer is between about 1 to 5.

32. The method of claim 17, wherein the crystalline soft magnetic underlayer is with a fcc[111] or a hcp [00.2] orientation normal to the base structure
